(19) United States
(12) Patent Application Publication
(10) Pub. No.: US 2008/0267421 A1
(43) Pub. Date: Oct. 30, 2008

(54) REDUCING CHASSIS INDUCED NOISE WITH A MICROPHONE ARRAY

(75) Inventor: Lee Atkinson, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/741,794

(22) Filed: Apr. 30, 2007

(51) Int. Cl. G10K 11/16

(52) U.S. Cl. 381/71.2

(57) ABSTRACT

A system for reducing noise induced from a chassis is described. The system comprises a signal processing engine, a first microphone connected to a chassis and communicatively coupled to the signal processing engine, a dampener connected to the chassis, and a second microphone connected to the dampener and communicatively coupled to the signal processing engine.

### BACKGROUND

A device having an integrated microphone, e.g., a cellular telephone or a notebook computer, detects noise transmitted through vibration of the device chassis or through mechanical feedback from an integrated loudspeaker of the device. Chassis vibration is communicated to the diaphragm of a microphone, e.g., an electret microphone element. The vibration-based noise is undesired and corrupts the intelligibility of airborne sound.

Previous approaches to reducing chassis-induced noise have attempted to isolate a receiving microphone from the chassis, e.g., by positioning a dampening material between the microphone and the chassis. The effect of the dampening material relies on the size of the solution. A limited amount of dampening material is used when constrained by a small physical size and thereby limits the effect of the dampening material to reducing induced noise.

### DESCRIPTION OF THE DRAWINGS

One or more embodiments is illustrated by way of example, and not by limitation, in the figures of the accompanying drawings, wherein elements having the same reference numeral designations represent like elements throughout and wherein:

FIG. 1 is a high-level functional block diagram of a system for reducing noise from a chassis according to an embodiment;

FIG. 2 is a graph of signals received from microphones according to an embodiment;

FIG. 3 is a graph of a signal generated based on the received signals according to an embodiment;

FIG. 4 is a high-level functional block diagram of a system for reducing noise from a chassis according to another embodiment;

FIG. 5 is a high-level functional block diagram of a system for reducing noise from a chassis according to another embodiment;

FIG. 6 is a high-level functional block diagram of a signal flow for reducing chassis noise according to an embodiment;

FIG. 7 is an example signal received from an un-dampened microphone according to an embodiment;

FIG. 8 is an example signal received from a dampened microphone according to an embodiment;

FIG. 9 is an example notch filter generated according to an embodiment; and

FIG. 10 is an example reduced chassis noise signal generated according to an embodiment.

### DETAILED DESCRIPTION

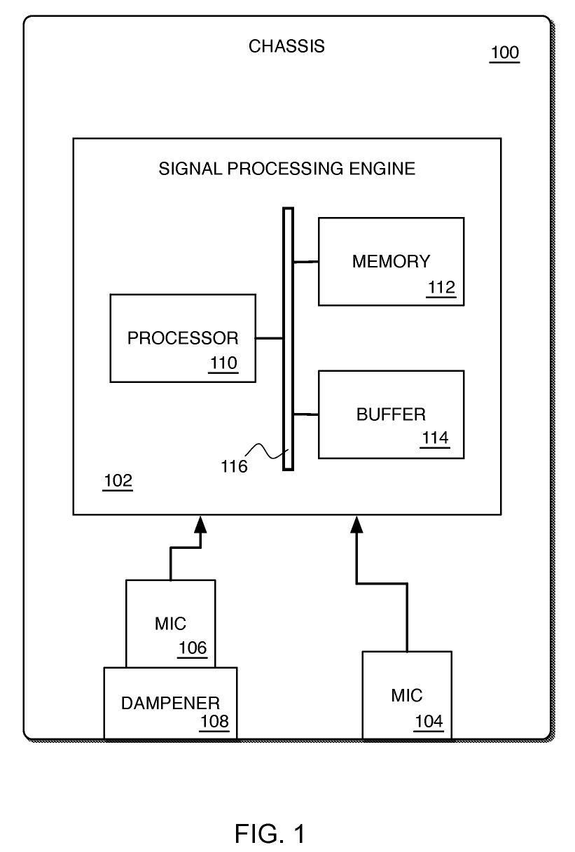

FIG. 1 depicts a chassis 100, e.g., a laptop or notebook computer case, a personal electronic device such as a cellular telephone, a personal digital assistant, etc. comprising at least a signal processing engine 102, a first microphone 104 connected to the chassis, a second microphone 106 connected to a dampening connection 108 (“dampener”) which is, in turn, connected to the chassis. Second microphone 106 is referred to as dampened microphone. In at least some embodiments, first microphone 104 is directly connected to chassis 100. In at least some embodiments, dampened microphone 106 is directly connected to dampener 108 which is directly connected to chassis 100.

Dampener 108 reduces the transmission of vibrations from chassis 100 to dampened microphone 106. In at least some embodiments, dampener 108 comprises an elastically-deformable material which reduces the amplitude of received vibrations. In at least some embodiments, dampener 108 comprises a rubber or foam material to which second microphone 106 is attached and which is, in turn, attached to chassis 100. In at least some embodiments, dampener 108 comprises a suspension mounting mechanism.

First microphone 104, lacking dampener 108, receives the transmission of vibrations from chassis 100. The vibrations may be caused by one or more devices within and/or in contact with the chassis 100, e.g., a speaker, a fan, a hard drive, a keyboard, etc., and/or interaction with the chassis such as by a user, e.g., handling the device comprising the chassis.

First microphone 104 and second microphone 106 are each communicatively coupled to signal processing engine 102. In at least some embodiments, first microphone 104 and second microphone 106 are electrically connected to signal processing engine 102. In at least some embodiments, first microphone 104 and second microphone 106 are spatially arranged to receive airborne audio signals in correspondence with the position of the signal generator with respect to the microphones, e.g., first microphone 104 may receive signals generated external to chassis 300 at one side such as a right-hand side and second microphone 106 may receive signals generated external to the chassis at another side such as a left-hand side.

First microphone 104 receives airborne and mechanically-induced audio signals, converts the received signal to a first electronic waveform signal and transfers the first electronic waveform signal to signal processing engine 102. Similarly, second microphone 106 receives airborne and dampened mechanically-induced audio signals, converts the received signals to a second electronic waveform signal and transfers the second electronic waveform signal to signal processing engine 102.

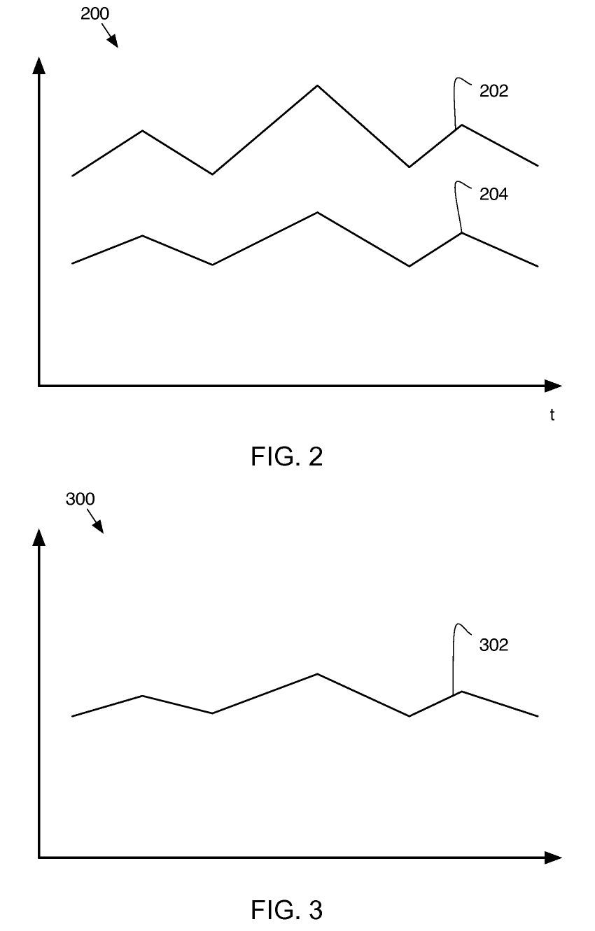

Signal processing engine 102 receives the transmitted electronic waveform signal from each of first microphone 104 and second microphone 106. FIG. 2 depicts a graph 200 of example electronic waveform signals received by signal processing engine 102. First microphone 104 generates a first electronic waveform signal 202 and second microphone 106 generates a second electronic waveform signal 204. Graph 200 comprises a plot of signals wherein the horizontal axis represents time (t) and the vertical axis represents amplitude of the signal.

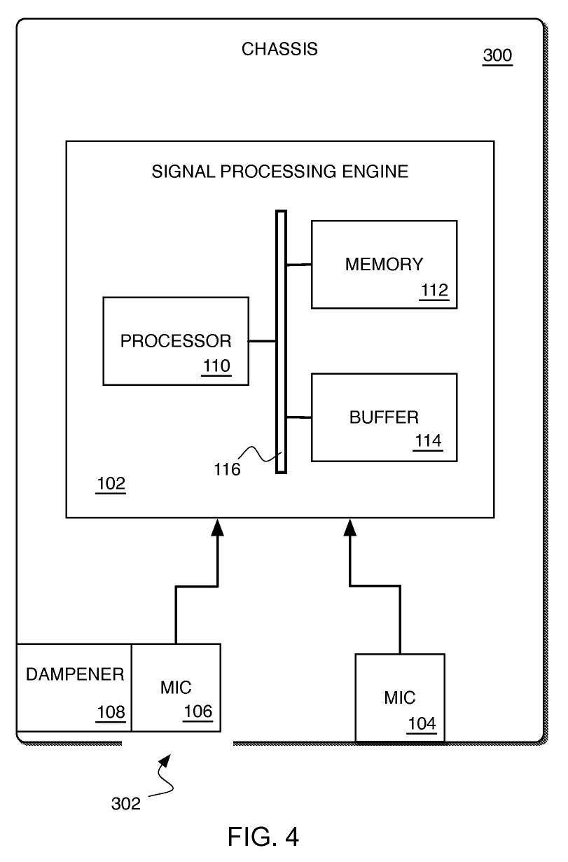

Responsive to receipt of the transmitted electronic waveform signals, signal processing engine 102 subtracts the second electronic waveform signal from the first electronic waveform signal to generate a mask signal which is applied to the first electronic waveform signal to generate a third electronic waveform signal as depicted in FIG. 3. FIG. 3 depicts a graph 300 of an example third electronic waveform signal 302 generated as a result of operation of signal processing engine 102. Third electronic waveform signal 302 represents the first electronic waveform signal without the mechanically-induced audio signal, i.e., a noise-reduced version of the first electronic waveform signal.

In at least some embodiments, signal processing engine 102 applies an adaptive filter, e.g., a Fast Fourier Transform (FFT), to each of the first and second electronic waveform signals to create a histogram of each signal in order to identify the difference between the channels, i.e., a histogram of a mask signal representing the mechanically-induced audio signal. Signal processing engine 102 applies the mask signal to the first electronic waveform signal to generate the third electronic waveform signal which does not comprise vibrations received from chassis 100. In at least some embodiments, the mask signal represents at least a portion of the mechanically-induced audio signal. In at least some embodiments, third electronic waveform signal 302 comprises a reduced amount of the mechanically-induced audio signal.

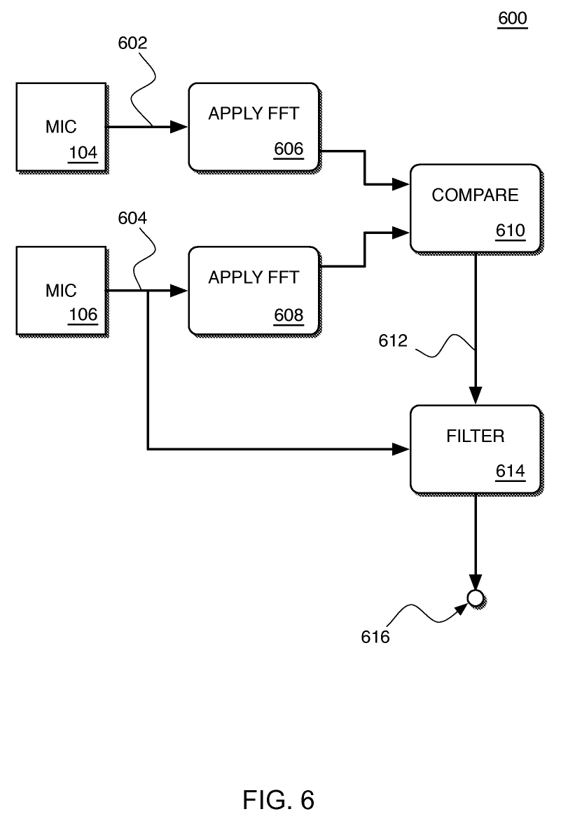

FIG. 6 depicts a functional signal flow diagram of application of a chassis noise reducing method 600 according to an embodiment in which first microphone 104 generates a first signal 602 which may comprise both airborne audio signals and chassis-induced audio signals. Second microphone 106 generates a second signal 604 which may comprise airborne audio signals and dampened chassis-induced audio signals.

As depicted in FIG. 6, signal processing engine 102 applies an FFT (apply FFT functionality 606) to first signal 602 and applies an FFT (apply FFT functionality 608) to second signal 604. In at least some embodiments, application of FFT to first and second signals 602, 604 identifies frequency components, e.g., frequency and magnitude, of the signals.

Signal processing engine 102 compares (compare functionality 610) the resulting signals from apply FFT 606 and apply FFT 608. As between first signal 602 and second signal 604, airborne audio signal components are similar in magnitude and chassis-induced audio signal components, which are common to both the first and second signals, are at a relatively lower magnitude in second signal 604. Signal processing engine 102 generates a mask signal 612 as a result of compare functionality 610.

Signal processing engine 102 uses mask signal 612 as the basis for a notch filter 614 which the signal processing engine applies to second signal 604. Application of notch filter 614 to second signal 604 by signal processing engine 102 reduces the magnitude of chassis-induced audio signal components in second signal 604 and generates resulting filtered audio signal 616, i.e., reduced chassis-induced noise audio signal.

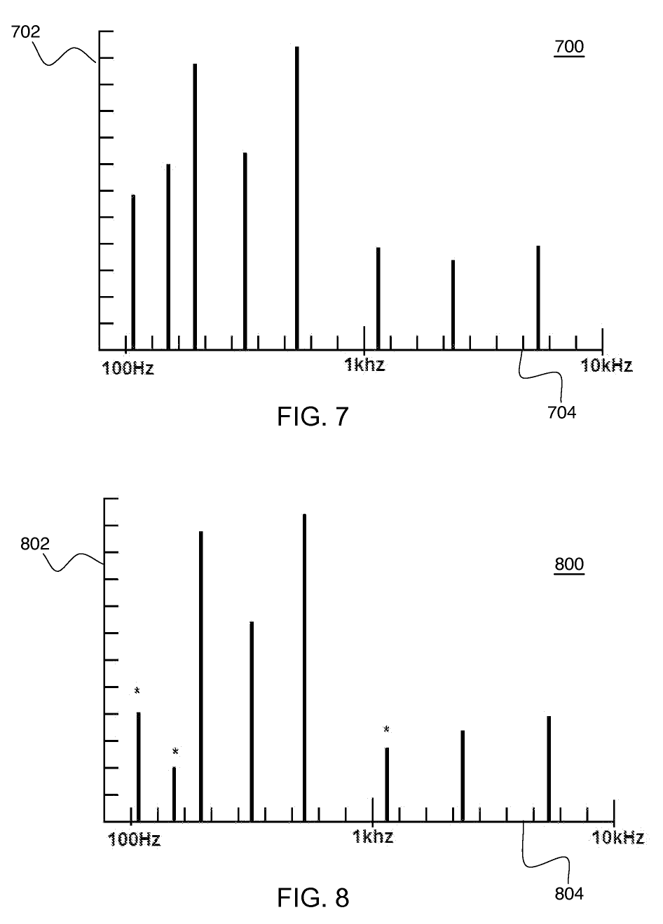

FIG. 7 depicts a graph 700 (un-dampened graph) of a first signal 602 generated by signal processing engine 102 as a result of apply FFT functionality 606 and FIG. 8 depicts a graph 800 (dampened graph) of a second signal 604 generated by the signal processing engine as a result of apply FFT functionality 608. FIGS. 7 and 8 represent digitized versions of audio signals. In at least some embodiments, non-digitized signals may be used. Graph 700 comprises a vertical axis 702 representing signal magnitude and a horizontal axis 704 representing the frequency of the graphed signal and similarly for FIG. 8, vertical axis 802 represents signal magnitude and horizontal axis 804 represents the frequency of the graphed signal. Un-dampened graph 700 and dampened graph 800 each comprise similar frequency components at 120 Hertz (Hz), 280 Hz, 350 Hz, 550 Hz, 720 Hz, 1700 Hz, 4200 Hz, and 7600 Hz, however, the amplitude of dampened graph 800 is lower than un-dampened graph 700 at the 120 Hz, 280 Hz, and 1700 Hz components.

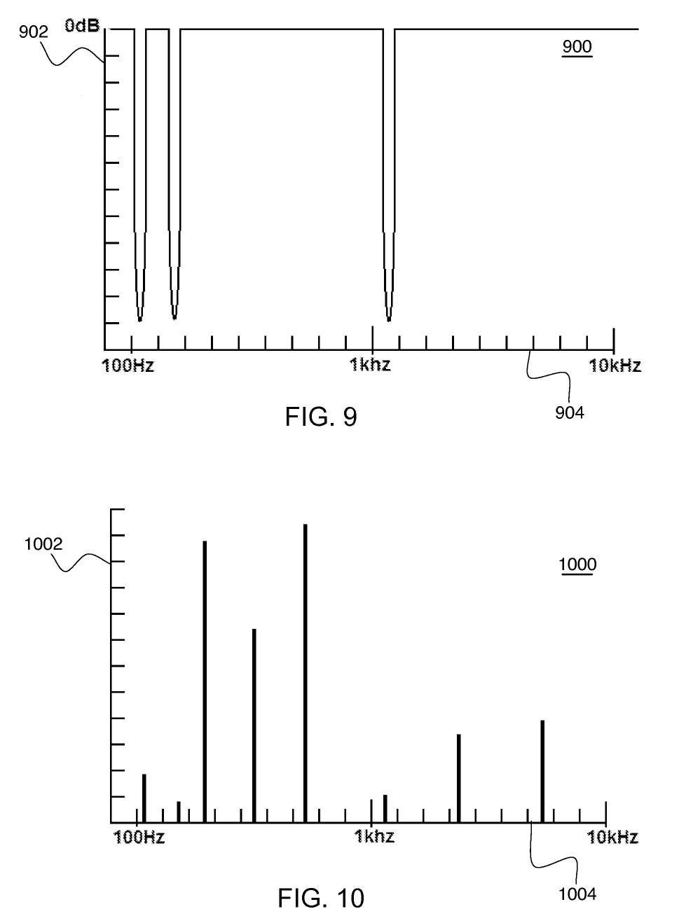

FIG. 9 depicts a graph 900 (notch filter graph) of a mask signal generated (FIG. 6, compare functionality 610) based on the signal of un-dampened graph 700 and the signal of dampened graph 800. Vertical axis 902 represents a gain applied and horizontal axis 904 represents the frequency.

FIG. 10 depicts a graph 1000 of a result signal generated after application of the mask signal of notch filter graph 900 to second signal 604 (dampened signal). Vertical axis 1002 represents the magnitude of the signal and horizontal axis 1004 represents the frequency of the signal.

Signal processing engine 102 comprises a processor 110, a memory 112, and a buffer 114 each communicatively coupled with a bus 116. Bus 116 transfers signals between processor 110, memory 112, and buffer 114. In at least some embodiments, bus 116 communicatively couples electronic waveform signals from first microphone 104 and second microphone 106 to one or more of processor 110, memory 112, and buffer 114. In at least some embodiments, buffer 114 receives electronic waveform signals from first microphone 104 and second microphone 106. In at least some embodiments, buffer 114 receives the electronic waveform signals directly from microphones 104, 106. In at least some embodiments, first and second microphones 104, 106 may generate the electronic waveform signals in analog and/or digital form.

In at least some embodiments, memory 112 may store a set of instructions for execution by processor 110 to perform operations on the received electronic waveform signals from first and second microphones 104, 106. In at least some embodiments, memory 112 and buffer 114 may be combined into a single component.

FIG. 4 depicts a high-level functional block diagram of another embodiment similar to the FIG. 1 embodiment. FIG. 4 depicts a chassis 300 comprising at least one defined opening 302 through which airborne audio signals may be received by second microphone 106. In at least some embodiments, second microphone 106 receives more airborne audio signals than first microphone 104. In at least some embodiments, first microphone 104 receives attenuated airborne audio signals from defined opening 302.

Second microphone 106 is positioned adjacent defined opening 302 in order to receive airborne audio signals through the opening. As in FIG. 1, second microphone 106 connects with chassis 300 via dampener 108 which is connected with the chassis.

First microphone 104 is positioned remote from defined opening 302 in order to reduce the airborne audio signals received through the opening. In this manner, first microphone 104 receives less attenuated mechanically-induced audio signals than second microphone 106.

In at least some embodiments, chassis 300 may comprise an additional defined opening adjacent first microphone 104. In at least some embodiments, defined opening 302 may be sized sufficiently large so that first microphone 104 and second microphone 106 may be positioned proximate the defined opening.

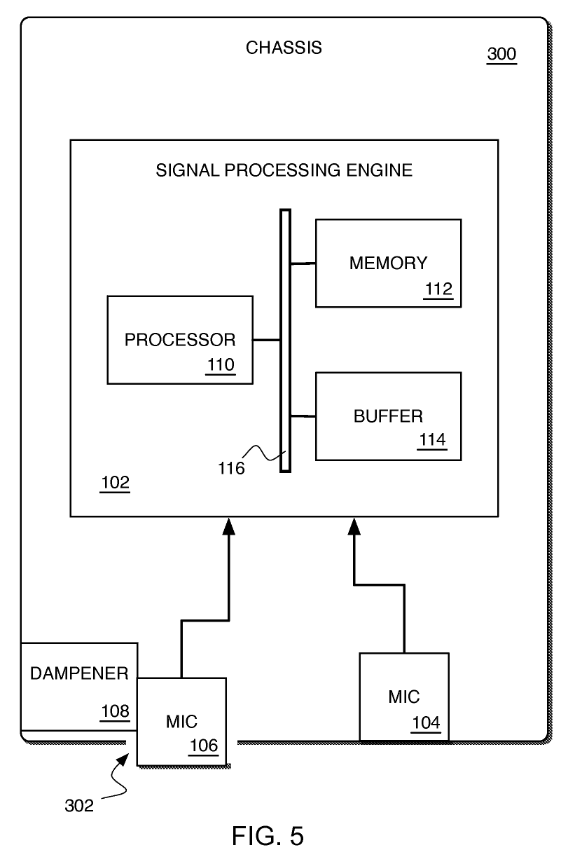

In at least some embodiments and as depicted in FIG. 5, second microphone 106 may extend at least partially through defined opening 302 to the exterior of the chassis.

In at least some further embodiments, chassis 300 may comprise a plurality of defined openings adjacent a plurality of microphones where a portion of the microphones are connected with the chassis via a corresponding plurality of dampeners and a portion of the microphones are directly connected with the chassis.

For example, in at least some embodiments, chassis 300 comprises a third microphone communicatively coupled to signal processing engine 102. The third microphone is also connected to a second dampener which is, in turn, connected to chassis 300. The second dampener, to which the third microphone is connected, comprises a dampening material having different dampening properties from dampener 108 to which second microphone 106 is connected. In at least some embodiments, the second dampener comprises a different dampening material from dampener 108. In operation, signal processing engine 102 receives first electronic waveform signal 202 from first microphone 104, second electronic waveform signal 204 from second microphone 106, and a fourth electronic waveform signal from the third microphone.

Similar to the above-described operations, signal processing engine 102 applies an adaptive filtering technique to first electronic waveform signal 202, second electronic waveform signal 204, and the fourth electronic waveform signal to generate a mask signal. Signal processing engine 102 applies the generated mask signal to first electronic waveform signal 202 to generate a reduced noise (such as mechanically-induced noise) version of first electronic waveform signal, i.e., third electronic waveform signal 302.

In at least some further embodiments, one or more microphones may each be connected with chassis 300 via a different dampener 108, i.e., each of the “dampened” microphones may be connected using a dampener material having a different dampening property.

In at least some embodiments, more than two microphones may be used to receive airborne and mechanically-induced audio signals.

What is claimed is:

1. A system for reducing noise induced from a chassis, comprising:
a signal processing engine;
a first microphone connected to a chassis and communicatively coupled to the signal processing engine;
a dampener connected to the chassis; and
a second microphone connected to the dampener and communicatively coupled to the signal processing engine.

2. The system as claimed in claim 1, wherein the first microphone is directly connected to the chassis.

3. The system as claimed in claim 1, wherein the second microphone is directly connected to the dampener.

4. The system as claimed in claim 1, wherein the signal processing engine is arranged to subtract a signal received at the second microphone from a signal received at the first microphone.

5. The system as claimed in claim 1, wherein the dampener comprises an elastically-deformable material.

6. The system as claimed in claim 1, wherein the chassis defines a throughhole from the chassis exterior to the chassis interior.

7. The system as claimed in claim 6, wherein the second microphone is positioned adjacent the defined throughhole.

8. The system as claimed in claim 6, wherein the second microphone extends at least partially through the defined throughhole.

9. The system as claimed in claim 6, wherein the first microphone and the second microphone are positioned adjacent the defined throughhole.

10. The system as claimed in claim 6, wherein the chassis further defines another throughhole from the chassis exterior to the chassis interior.

11. The system as claimed in claim 10, wherein the first microphone is positioned adjacent the another throughhole.

12. The system as claimed in claim 1, wherein the first microphone is spatially separated from the second microphone.

13. The system as claimed in claim 1, further comprising:
another dampener connected to the chassis; and
a third microphone connected to the another dampener and communicatively coupled to the signal processing engine.

14. The system as claimed in claim 13, wherein the another dampener comprises a material having a dampening property different from the material of the dampener.

15. A method of reducing received noise from a chassis, comprising:
receiving a first signal from a first microphone connected to a chassis;
receiving a second signal from a second microphone connected to a dampener connected to the chassis; and
deriving a third signal based on the first signal and the second signal.

16. The method as claimed in claim 15, wherein the deriving comprises subtracting a mask signal from the second signal, wherein the mask signal is based on the first signal and the second signal.

17. The method as claimed in claim 15, wherein the deriving comprises:
generating a mask signal by applying an adaptive filter to the first signal and the second signal; and
generating the third signal based on application of the mask signal to the second signal.

18. The method as claimed in claim 15, further comprising:
receiving a fourth signal from a third microphone connected to another dampener connected to the chassis; and
wherein deriving a third signal comprises deriving the third signal based on the first signal, the second signal, and the fourth signal.

19. A computer-readable medium storing instructions which, when executed by a processor, cause the processor to receive a first signal from a first microphone connected to a chassis, receive a second signal from a second microphone connected to a dampener connected to the chassis, and derive a third signal based on the first signal and the second signal.

20. The computer-readable medium as claimed in claim 19 wherein the instructions which, when executed by the processor, cause the processor to derive a third signal comprise instructions to generate a mask by applying an adaptive filter to the first signal and the second signal; and generate the third signal based on application of the mask to the second signal.
